(19) United States
(12) Patent Application Publication
(10) Pub. No.: US 2012/0219778 A1
(43) Pub. Date: Aug. 30, 2012

(54) COMPOSITE MATERIAL CONTAINING SOFT CARBON FIBER FELT AND HARD CARBON FIBER FELT

(75) Inventors: SEBASTIAN KAPAUN, OBERNDORF (DE); OSWIN ÖTTINGER, MEITINGEN (DE); KARL HINGST, AUGSBURG (DE); ELMAR EBER, KUEHLENTHAL (DE)

(73) Assignee: SGL CARBON SE, WIESBADEN (DE)

(21) Appl. No.: 13/441,022

(22) Filed: Apr. 6, 2012

Related U.S. Application Data
(63) Continuation of application No. PCT/EP2010/062051, filed on Aug. 18, 2010.

(30) Foreign Application Priority Data
Oct. 6, 2009 (DE) 102009048422.1

(51) Int. Cl. B32B 7/02; B32B 37/14; D04H 13/00

(52) U.S. Cl. 428/217; 156/60

(57) ABSTRACT

A composite contains a binder, at least one layer of a soft carbon fiber felt, and at least one layer of a hard carbon fiber felt. The at least one layer of soft carbon fiber felt is joined via the binder to the at least one layer of hard carbon fiber felt.

### CROSS-REFERENCE TO RELATED APPLICATION

This is a continuation application, under 35 U.S.C. §120, of copending international application No. PCT/EP2010/062051, filed Aug. 18, 2010, which designated the United States; this application also claims the priority, under 35 U.S.C. §119, of German patent application No. DE 10 2009 048 422.1, filed Oct. 6, 2009; the prior applications are herewith incorporated by reference in their entirety.

### BACKGROUND OF THE INVENTION

### Field of the Invention

The present invention relates to a composite and in particular a high-temperature-resistant composite.

Materials based on carbon are frequently used as thermal insulation in high-temperature applications, for example as thermal insulation in high-temperature furnaces, owing to their high thermal stability and their chemical inertness toward the substances present in the interior of the furnace. To prevent both heat losses due to heat radiation and heat losses due to heat conduction and convection, composites containing, for example, a layer of carbon fiber-reinforced carbon and a graphite foil have already been proposed as thermal insulation in high-temperature applications. Here, the layer of carbon fiber-reinforced carbon prevents, in particular, heat loss as a result of thermal conduction while the graphite foil is reflective and therefore prevents heat loss as a result of heat radiation.

However, thermal insulation based on hard carbon fiber felt is frequently used in practice because of its excellent thermal insulation properties. However, hard carbon fiber felt is very brittle, which is why it is difficult to work. Owing to these properties, material can, in particular, crumble away at the corners of the plates when cutting hard felt plates to size, which can lead to the plates no longer fitting accurately into the component to be insulated. This problem occurs particularly when individual regions of the hard felt insulation are to be replaced in an existing insulation based on hard felt, so that new hard felt material has to be fitted accurately into existing insulation from which parts to be replaced have previously been removed. Furthermore, hard carbon fiber felts are comparatively expensive because of their complex production process. Finally, the thermal insulation properties of hard carbon fiber felts are capable of improvement.

### SUMMARY OF THE INVENTION

It is accordingly an object of the invention to provide a composite material containing a soft carbon fiber felt and a hard carbon fiber felt which overcomes the above-mentioned disadvantages of the prior art devices of this general type, which has excellent thermal insulation properties and is comparatively cheap to produce and, is simple to work, in particular simple to cut to exact dimensions.

The object is achieved according to the invention by a composite containing at least one layer of soft carbon fiber felt and at least one layer of hard carbon fiber felt, wherein the at least one layer of soft carbon fiber felt is joined via a binder to the at least one layer of hard carbon fiber felt.

This solution is based on the recognition that in the case of a composite in which at least one layer of hard carbon fiber felt is joined via a binder to at least one layer of soft carbon fiber felt, the positive properties of hard felt are not only retained but are even improved in respect of the thermal insulation properties and at the same time the negative properties of hard felt such as comparatively high brittleness, low compliance and high production costs can be overcome or at least significantly reduced. In particular, such a composite has a high compliance and low brittleness and is therefore easy to work and in particular can be cut to precise dimensions. Apart from this, such a composite is comparatively inexpensive because expensive hard felt therein is partly replaced by cheaper soft felt. In addition, this composite has, owing to the combination of soft felt-hard felt, better thermal insulation properties compared to a material of the same dimensions consisting of hard felt alone. Owing to these properties, the composite of the invention is, inter alia, highly suitable for use as thermal insulation in high-temperature furnaces. Owing to the ease of working it, the composite of the invention is also particularly suitable for use in the repair of existing thermal insulation based on hard felt, in which, for example, part of existing thermal insulation consisting of, for example, hard felt alone is replaced by accurately fitting composite according to the invention.

For the purposes of the present invention, hard (carbon fiber) felt is, in accordance with the definition customary in the technical field relevant here, a felt which contains not only carbon fibers but also a matrix composed of binder, while soft (carbon fiber) felt is a felt which does not contain any matrix or any binder. For this reason, soft felt is flexible while hard felt is dimensionally stable.

Furthermore, for the purposes of the present invention carbon fibers are, likewise in accordance with the definition customary in the technical field relevant here, fibers in general composed of carbon-containing starting materials.

According to the invention, the at least one layer of soft carbon fiber felt is joined via a binder to the at least one layer of hard carbon fiber felt. Therefore the two layers are directly joined to one another by the action of a binder, where the binder can be present as intermediate layer between the soft felt layer and the hard felt layer or the soft felt layer and the hard felt layer can be joined to one another by binder present at the interfaces of the adjacent felt layers without an intermediate layer of binder having to be present between the two felt layers. This joining is preferably a large-area joining, i.e. the two felt layers are joined to one another by a binder at least substantially over their entire contact area. Here, the contact area of the two felt layers is preferably formed in each case by a flat side of the felt layers. Since the two flat sides are never completely or ideally planar, the two flat sides will in reality not be in full-area contact but contact one another via a plurality of contact regions. In this case, preference is given to at least virtually all contact regions being joined to one another via a binder.

As binders for this purpose, it is possible to use all binders which can firmly join a hard felt layer and a soft felt layer to one another, with particular preference being given to using carbon-containing binders and very particular preference being given to using those selected from the group consisting of phenolic resins, pitches, furan resins, phenyl esters, epoxy resins and any mixtures of two or more of the abovementioned compounds. In a highly preferred embodiment of the present invention, a binder which is selected from the abovementioned group and contains platelet-like particles of natural graphite and/or expanded graphite, where platelet-like particles are for the present purposes particles which have a larger dimension in the area (diameter) than the thickness, is used. The average diameter of the particles can be, for example, in the range from 1 to 250 μm and preferably from 5 to 55 μm. Such binders have a high degree of anisotropy, with heat conduction being only low across the interface between the adjoining layers because the platelet-like anisotropic particles become aligned parallel to the adjoining layers of material. These binders are then cured thermally and/or chemically, with chemical curing being able to be achieved by, for example, addition of acid and thermal curing being able to be carried out at, for example, a temperature of at least 50° C. and preferably from 100 to 200° C. After curing, carbonization or graphitization can optionally be carried out.

The at least one layer of soft carbon fiber felt can in principle have any layer thickness. However, good results are obtained, particularly in respect of excellent thermal insulation properties and good workability of the composite, when the at least one layer of soft carbon fiber felt has a thickness in the range from 1 to 100 mm, preferably from 1 to 50 mm and particularly preferably from 2 mm to 20 mm.

In respect of the density and the weight per unit area of the at least one layer of soft carbon fiber felt, too, the present invention is not limited in any particular way. However, in terms of achieving excellent thermal insulation properties and good workability of the composite, it has been found to be advantageous for the at least one layer of soft carbon fiber felt to have a density in the range from 0.01 to 1 g/cm³, preferably from 0.05 to 0.5 g/cm³ and particularly preferably from 0.08 to 0.15 g/cm³.

For the same reasons, preference is given to the at least one layer of soft carbon fiber felt having a weight per unit area in the range from 50 to 10,000 g/m², particularly preferably from 100 to 5,000 g/m² and very particularly preferably from 200 to 1,500 g/m².

In a further development of the inventive concept, it is proposed that the carbon fibers of the at least one soft felt layer have a length in the range from 0.1 to 500 mm, preferably from 1 to 250 mm and particularly preferably from 40 to 100 mm.

In a further preferred embodiment of the present invention, the carbon fibers of the at least one soft felt layer have a fineness in the range from 0.1 to 100 dtex, preferably from 0.5 to 25 dtex and particularly preferably from 1 to 5 dtex.

The soft carbon fiber felt layer can be produced by felting together fibers composed of suitable starting materials by a felting process before the felt is carbonized or optionally graphitized. The carbonization is preferably carried out at a temperature of at least 600° C. and not more than 1,500° C., while the optional graphitization is preferably carried out at a temperature in the range from 2,000° C. to 2,500° C. Carrying out a graphitization is particularly preferred when the composite produced using the soft felt layer is to be particularly stable or inert toward chemicals, in particular toward molecular oxygen. The carbonization or graphitization can also be carried out as a final step in the production of the composite, namely only after the individual layers of the composite have been arranged above one another.

As an alternative to the abovementioned embodiment, the soft carbon fiber felt layer can also be produced by first carbonizing or graphitizing fibers composed of suitable starting materials before the carbon fibers obtained in this way are felted.

In both the abovementioned embodiments, fibers composed of any carbon-containing material can be used as starting fibers as long as the material can be carbonized to form carbon or graphitized to form graphite by a heat treatment. Fibers which have been found to be particularly suitable for this purpose are cellulose fibers, polyacrylonitrile fibers (PAN fibers), peroxidized polyacrylonitrile fibers (PANOX fibers) and pitch fibers. Preference is given to using monofilaments of one material, for example exclusively polyacrylonitrile fibers. However, it is also possible to use a fiber mixture, for example a mixture of polyacrylonitrile fibers and cellulose fibers, or bifilaments, i.e. fibers which contain both polyacrylonitrile and cellulose, for example in the form of a core-shell structure.

Like the soft carbon fiber felt layer, the at least one layer of hard carbon fiber felt preferably has a layer thickness in the range from 1 to 100 mm, preferably from 1 to 50 mm and particularly preferably from 2 mm to 20 mm.

In a further development of the inventive concept, it is proposed that the at least one layer of hard carbon fiber felt has a density in the range from 0.02 to 2 g/cm³, particularly preferably from 0.1 to 1.0 g/cm³ and very particularly preferably from 0.15 to 0.3 g/cm³.

In a further preferred embodiment of the present invention, the weight per unit area of the at least one layer of hard carbon fiber felt is in the range from 200 to 50,000 g/m² and particularly preferably from 3,000 to 10,000 g/m².

The length and fineness of the carbon fibers present in the at least one hard felt layer preferably correspond to the values indicated above in respect of the soft felt layer. The length of the fibers of the at least one hard felt layer is thus preferably in the range from 0.1 to 500 mm, particularly preferably from 1 to 250 mm and very particularly preferably from 3 to 100 mm, while the fineness of the fibers of the at least one hard felt layer is preferably in the range from 0.1 to 100 dtex, particularly preferably from 0.5 to 25 dtex and very particularly preferably from 1 to 5 dtex.

The at least one layer of hard carbon fiber felt can in principle contain any suitable carbon-containing binders as long as the binders can be carbonized to form carbon or graphitized to form graphite by a heat treatment. Particularly suitable binders for the hard felt layer have been found to be carbon-containing binders selected from the group consisting of phenolic resins, pitches, furan resins, phenyl esters, epoxy resins and any mixtures of two or more of the above-mentioned compounds.

In a further development of the inventive concept, it is proposed that the at least one hard felt layer have a composition such that the layer has a flexural strength measured in accordance with DIN 29971 in the range from 0.1 to 20 MPa, preferably from 0.2 to 5 MPa and particularly preferably from 0.5 to 1.5 MPa.

To produce the hard carbon fiber felt layer, a soft carbon fiber felt can be impregnated with a suitable binder, in particular with a binder selected from the group consisting of phenolic resins, pitches, furan resins, phenyl esters, epoxy resins and any mixtures of two or more of the abovementioned compounds before the impregnated felt is carbonized or graphitized under the conditions mentioned above in respect of the production of the soft felt layer. Here too, preference is given to using cellulose fibers, polyacrylonitrile fibers, peroxidized polyacrylonitrile fibers, pitch fibers or any mixtures of two or more of the abovementioned fibers as starting fibers.

As an alternative, the at least one layer of hard carbon fiber felt can also be produced by mixing of cellulose fibers, polyacrylonitrile fibers, peroxidized polyacrylonitrile fibers and/or pitch fibers with binder, subsequent pressing of the fibers and then carbonization or graphitization.

In a further alternative, only a felt mixture which, for example, has been cured by pressing, evacuation, treatment in an oven, treatment in a drying chamber, treatment in an autoclave or chemically by addition of a hardener and can be carbonized and/or graphitized after arrangement of the individual layers of the composite above one another together with the other layers of the composite is used.

As regards the hard felt and soft felt layers, the present invention is not subject to any restrictions. However, the composite can have only one soft felt layer and one hard felt layer or have in each case two, three or more soft felt layers and hard felt layers. The composite of the invention can equally well have a different number of soft felt layers and hard felt layers, for example one soft felt layer and two or more hard felt layers or one hard felt layer and two or more soft felt layers. Here, at least one hard felt layer is joined over its area via a binder to at least one soft felt layer, but preference is given to all adjacent hard felt layers and soft felt layers being joined to one another over a large area via a binder.

In a preferred embodiment of the present invention, the composite has a symmetrical structure in respect of the arrangement of the hard felt and soft felt layers.

For example, the composite can comprise a central layer of hard carbon fiber felt which is surrounded on both sides by in each case a layer of soft carbon fiber felt, with the two layers of soft carbon fiber felt being in each case joined to the layer of hard carbon fiber felt via a binder. A complementary structure, i.e. a composite having a central layer of soft carbon fiber felt which is surrounded on both sides by in each case a layer of hard carbon fiber felt, with the two layers of hard carbon fiber felt being joined to the layer of soft carbon fiber felt in each case via a binder, is likewise suitable. The abovementioned composites can consist of these arrangements, i.e. have no further layers, or can have additional layers of another material, for example one or more graphite foils and/or one or more layers of carbon fiber-reinforced carbon.

In a further development of the inventive concept, it is proposed that in both the abovementioned embodiments the outer layers be in each case surrounded by a further, complementary felt layer. This leads to a structure having a central layer of hard carbon fiber felt which is surrounded on both sides by in each case a layer of soft carbon fiber felt on each of which a layer of hard carbon fiber felt is in turn arranged, or to a complementary structure having a central layer of soft carbon fiber felt which is surrounded on both sides by in each case a layer of hard carbon fiber felt on each of which a layer of soft carbon fiber felt is in turn arranged.

To increase, for example, the impermeability or barrier properties of the composite in respect of heat radiation and gases, the composite can have not only at least one soft felt layer and at least one hard felt layer but also one or more further layers which are, for example, composed of carbon fiber-reinforced carbon and/or graphite foil. This/these further layer(s) is/are preferably applied to one of the outermost layers of the composite or to both of the outermost layers of the composite and joined to this/these via a binder. However, it is also possible for at least one intermediate layer of such a material to be provided between individual felt layers as long as at least one soft felt layer is joined directly to at least one hard felt layer, i.e. without an intermediate layer (apart from binder).

For example, in the abovementioned embodiment in which the composite comprises a central layer of hard carbon fiber felt which is surrounded on both sides by in each case a layer of soft carbon fiber felt, a graphite foil and/or a layer of carbon fiber-reinforced carbon can be arranged on the two outermost layers of soft carbon fiber felt, in each case on the outside. Analogously, in the embodiment in which the composite has a central layer of soft carbon fiber felt which is surrounded on both sides by in each case a layer of hard carbon fiber felt, a graphite foil and/or a layer of carbon fiber-reinforced carbon can be arranged on the two outer layers of hard carbon fiber felt, in each case on the outside.

If at least one graphite foil is provided in the composite of the invention, this foil preferably has a layer thickness in the range from 0.1 to 3 mm and particularly preferably from 0.3 to 1 mm. Such a graphite foil is highly reflective and gives the composite particularly good barrier properties, especially in respect of passage of gas.

In a further development of the inventive concept, it is proposed that the graphite foil consists of natural graphite and/or of expanded graphite.

In a further preferred embodiment of the present invention, the density of the graphite foil is from 0.1 to 1.5 g/cm³. Preference is given to using a dense-rolled graphite foil which has a density of about 1.0 g/cm³. However, it is also possible to use less dense rolled graphite foils, for example those having a density of about 0.3 g/cm³.

The at least one layer of carbon fiber-reinforced carbon (CFC) as optional constituent of the composite is composed of a carbon matrix in which carbon fibers are present. The carbon fibers can be continuous fibers, which is preferred, or staple fibers having, for example, a length in the range from 5 to 250 mm, preferably from 10 to 100 mm and particularly preferably from 50 to 100 mm, but this is less preferred.

In a further preferred embodiment of the present invention, the carbon fibers of the CFC layer are in the form of a woven fabric. In an alternative but equally preferred embodiment of the present invention, the carbon fibers of the CFC layer are in the form of a lay-up, with the individual fibers of the lay-up being able to be arranged unidirectionally or multi-axially.

The at least one CFC layer preferably has a layer thickness in the range from 0.1 to 1 mm.

Good results in respect of the conductivity are obtained particularly when the at least one CFC layer has a density in the range from 0.4 to 3 g/cm³, particularly preferably from 0.8 to 2.0 g/cm³ and very particularly preferably from 1.0 to 1.5 g/cm³.

As starting material for the matrix of the CFC layer, it is possible to use carbon-containing materials, in particular materials selected from the group consisting of phenolic resins, pitches, furan resins, phenyl esters, epoxy resins and any mixtures of two or more of the abovementioned compounds, while preference is given to using pitch or particularly preferably polyacrylonitrile or peroxidized polyacrylonitrile as starting material for the carbon fibers. It is also possible to use fiber mixtures of the abovementioned materials or bifilaments of two or more of the abovementioned starting materials. Here, the matrix can have a weight per unit area of from 100 to 1,500 g/m².

Such CFC layers can be produced, for example, by carbonizing or graphitizing peroxidized polyacrylonitrile fibers, polyacrylonitrile fibers and/or pitch fibers, then processing the resulting carbon fibers to give a woven fabric or lay-up which is subsequently impregnated with a binder before the structure obtained in this way is finally heat treated or optionally carbonized and/or graphitized. As binders, it is possible to use carbon-containing compounds, with preference once again being given to binders selected from the group consisting of phenolic resins, pitches, furan resins, phenyl esters, epoxy resins and any mixtures of two or more of the abovementioned compounds.

Owing to their abovementioned advantageous properties, the composites of the invention can be used, in particular, in heat shields, in thermal insulation, in furnace internals or in other high-temperature applications, for example in foundries. Owing to the ease with which it can be worked, the composite of the invention is also particularly suitable for use in the repair of existing thermal insulation, in which, for example, part of an existing thermal insulation consisting, for example, solely of hard felt is replaced by accurately fitting composite according to the invention.

The composites of the invention can have any desired shape. For example, they can have a wide shape, in particular a plate-like shape, or have a round cross section, i.e. a cylindrical or tubular shape. However, apart from these, the composites can also be present in other shapes including geometrically complex shapes.

The present invention further provides a process for producing a composite as described above, which includes the following steps:
a) provision of at least one layer of soft carbon fiber felt,
b) provision of at least one layer of hard carbon fiber felt, and
c) joining of the at least one layer of soft carbon fiber felt to the at least one layer of hard carbon fiber felt by a binder.

In process step b), the at least one layer of hard carbon fiber felt can be produced, for example, by impregnation of soft carbon fiber felt with a binder and subsequent heat treatment. As an alternative, the at least one layer of hard carbon fiber felt can be produced in process step b) by mixing of fibers with a binder, pressing of the mixture obtained in this way and subsequent heat treatment.

Furthermore, the process of the invention can, as step d), include the application of at least one graphite foil and/or at least one layer of carbon fiber-reinforced carbon to at least one of the carbon fiber felt layers.

To apply a layer of carbon fiber-reinforced carbon, it is possible, in process step d), for, for example, (peroxidized) polyacrylonitrile fibers and/or pitch fibers to be carbonized or graphitized, then the resulting carbon fibers to be processed to give a woven fabric or lay-up which is subsequently impregnated with a binder selected from the group consisting of phenolic resins, pitches, furan resins, phenyl esters, epoxy resins and any mixtures of two or more of the above-mentioned compounds before the structure obtained in this way is optionally carbonized and/or graphitized.

After arrangement of the individual layers above one another, the composite can optionally be cured, which can be effected, for example, by pressing, by evacuation, by treatment in an oven, by treatment in a drying chamber, by treatment in an autoclave or chemically by addition of a hardener.

Finally, the composite can subsequently be carbonized and/or graphitized.

Other features which are considered as characteristic for the invention are set forth in the appended claims.

Although the invention is illustrated and described herein as embodied in a composite material containing a soft carbon fiber felt and a hard carbon fiber felt, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, cross-sectional view of a composite according to the invention as per a first embodiment;

FIG. 2 is a cross-sectional view of the composite according to the invention as per a second embodiment;

FIG. 3 is a cross-sectional view of the composite according to the invention as per a third embodiment;

FIG. 4 is a cross-sectional view of the composite according to the invention as per a fourth embodiment;

FIG. 5 is a cross-sectional view of the composite according to the invention as per a fifth embodiment; and

FIG. 6 is a cross-sectional view of the composite according to the invention as per a sixth embodiment.

### DETAILED DESCRIPTION OF THE INVENTION

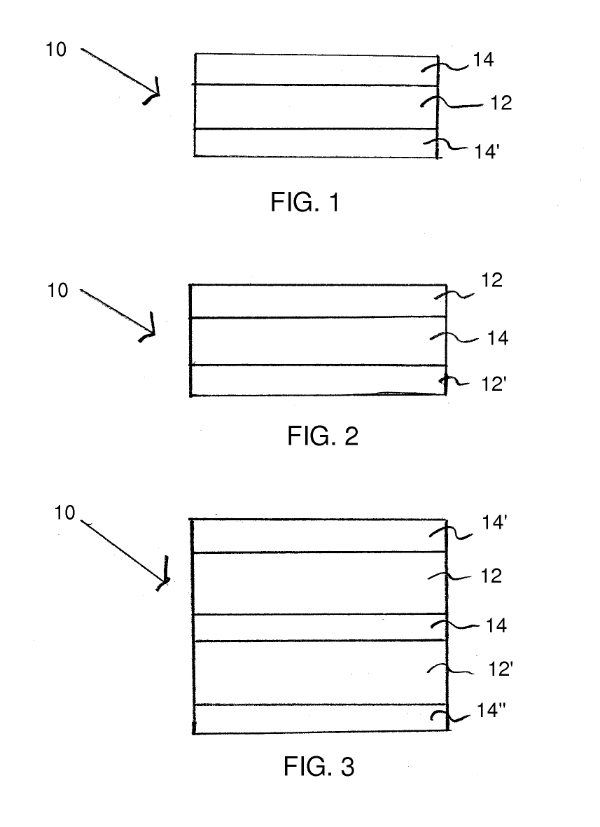

Referring now to the figures of the drawing in detail and first, particularly, to FIG. 1 thereof, there is shown a composite 10 which consists of a central layer of hard felt 12 on whose opposite sides a layer of soft felt 14, 14′ is in each case arranged, with the individual layers 12, 14, 14′ each being joined to one another over a large area via a binder (not shown). Here, the binder can be provided as an intermediate layer between two adjoining felt layers 12, 14 or 12, 14′. As an alternative, the binder can originate from the contact areas of the adjoining felt layers 12, 14, 14′.

In the composite 10 shown in FIG. 2, the individual layers are complementary to those of the composite shown in FIG. 1, i.e. the composite consists of a central layer of soft felt 14 on whose opposite sides a layer of hard felt 12, 12′ is in each case arranged, with the individual layers 14, 12 or 14, 12′ in each case being joined to one another over a large area via a binder (not shown).

The composite shown in FIG. 3 differs from that shown in FIG. 2 in that a further layer of soft felt 14′, 14″ is arranged on the outside of each of the two layers of hard felt 12, 12′.

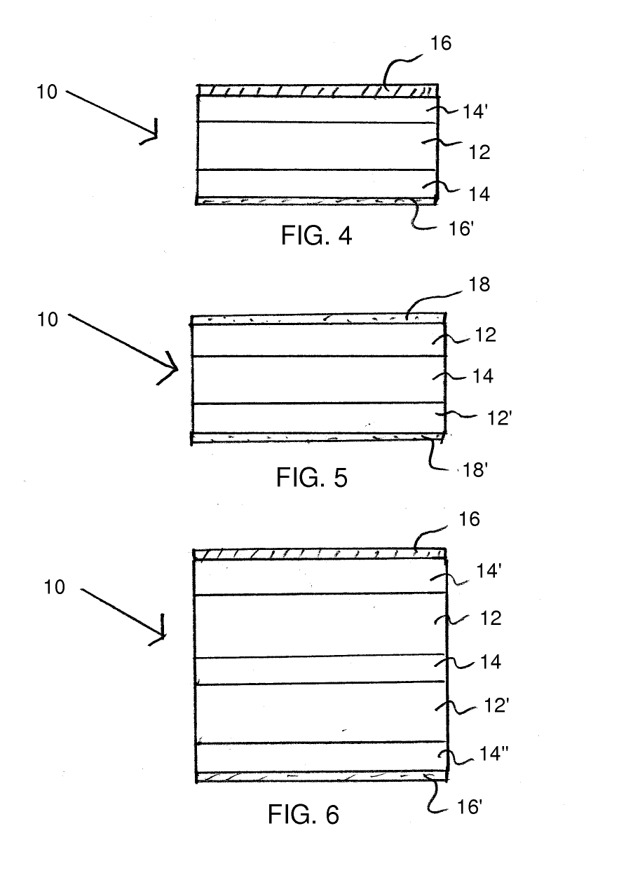

The composites shown in FIGS. 4 to 6 correspond to those shown in FIGS. 1 to 3, with the exception that a graphite foil 16, 16′ or a layer of carbon fiber-reinforced carbon 18, 18′ is in each case arranged on the outer felt layers 14, 14′ or 12, 12′ or 14′, 14″ which can be joined by a binder to the respective felt layer located underneath. As an alternative, it would also be possible to provide both a graphite foil and a layer of carbon fiber-reinforced carbon on the outer felt layers 14, 14′ or 12, 12′ or 14′, 14″, with the graphite foil in this case preferably being arranged on the outside of the layer of carbon fiber-reinforced carbon.

As an alternative to the sheet-like shape shown in FIGS. 1 to 6, the composites of the invention can also have any other shape, for example a cylindrical or tubular shape.

1. A composite, comprising:
a binder;
at least one layer of a soft carbon fiber felt; and
at least one layer of a hard carbon fiber felt, said at least one layer of soft carbon fiber felt being joined via said binder to said at least one layer of hard carbon fiber felt.

2. The composite according to claim 1, wherein said at least one layer of soft carbon fiber felt has a thickness in a range from 1 to 100 mm.

3. The composite according claim 1, wherein said at least one layer of soft carbon fiber felt has a density in a range from 0.01 to 1 g/cm³.

4. The composite according to claim 1, wherein said at least one layer of soft carbon fiber felt has a weight per unit area in a range from 50 to 10,000 g/m².

5. The composite according to claim 1, wherein said at least one layer of soft carbon fiber felt has carbon fibers with a length in a range from 0.1 to 500 mm.

6. The composite according to claim 1, wherein said at least one layer of soft carbon fiber felt has carbon fibers with a fineness in a range from 0.1 to 100 dtex.

7. The composite according to claim 1, wherein said at least one layer of soft carbon fiber felt is produced by felting and subsequent by one of carbonization or graphitization of fibers selected from the group consisting of cellulose fibers, polyacrylonitrile fibers, peroxidized polyacrylonitrile fibers and pitch fibers.

8. The composite according to claim 1, wherein said at least one layer of hard carbon fiber felt has a density in a range from 0.02 to 2 g/cm^{3.}

9. The composite according to claim 1, wherein said at least one layer of hard carbon fiber felt contains a carbon-containing binder selected from the group consisting of phenolic resins, pitches, furan resins, phenyl esters, epoxy resins and any mixtures of at least two of said abovementioned compounds.

10. The composite according to claim 1, wherein said binder via which said at least one layer of soft carbon fiber felt is joined to said at least one layer of hard carbon fiber felt is a carbon-containing binder selected from the group consisting of phenolic resins, pitches, furan resins, phenyl esters, epoxy resins and any mixtures of at least two of said abovementioned compounds.

11. The composite according to claim 1, wherein said at least one layer of soft carbon fiber felt is one of two layers of soft carbon fiber felt disposed on opposite sides of said at least one layer of hard carbon fiber felt, said two layers of soft carbon fiber felt are each joined via said binder to said layer of hard carbon fiber felt.

12. The composite according to claim 1, wherein said at least one layer of hard carbon fiber felt is one of two layers of hard carbon fiber felt disposed on opposite sides of said at least one layer of soft carbon fiber felt, said two layers of hard carbon fiber felt are each joined via said binder to said layer of soft carbon fiber felt.

13. The composite according to claim 12, further comprising further outer layers of soft carbon fiber felt each disposed on an outer side of said two layers of hard carbon fiber felt, said two further outer layers of soft carbon fiber felt are each joined via said binder to one of said layers of hard carbon fiber felt.

14. The composite according to claim 1, further comprising at least one graphite foil and at least one layer of carbon fiber-reinforced carbon each disposed on one of an outer side of one of said layers of soft or hard carbon fiber felt of the composite.

15. The composite according to claim 14, wherein said at least one graphite foil contains a natural graphite or an expanded graphite and has a layer thickness of from 0.1 to 3 mm.

16. The composite according to claim 14, wherein said at least one layer of carbon fiber-reinforced carbon contains one of continuous fibers or staple fibers having a length in a range from 5 to 250 mm.

17. The composite according to claim 14, wherein said layer of carbon fiber-reinforced carbon has fibers selected from the group consisting of a woven fabric and lay-up being one of unidirectional or multi-axial.

18. The composite according to claim 14, wherein said at least one layer of carbon fiber-reinforced carbon has a thickness in a range from 0.1 to 1 mm.

19. The composite according to claim 14, wherein said at least one layer of carbon fiber-reinforced carbon has a density in a range from 0.4 to 3 g/cm³.

20. The composite according to claim 1, wherein said at least one layer of soft carbon fiber felt has a thickness in a range from 1 to 50 mm.

21. The composite according to claim 1, wherein said at least one layer of soft carbon fiber felt has a thickness in a range from 2 to 20 mm.

22. The composite according claim 1, wherein said at least one layer of soft carbon fiber felt has a density in a range from 0.05 to 0.5 g/cm³.

23. The composite according claim 1, wherein said at least one layer of soft carbon fiber felt has a density in a range from 0.08 to 0.15 g/cm³.

24. The composite according to claim 1, wherein said at least one layer of soft carbon fiber felt has a weight per unit area in a range from 100 to 5,000 g/m².

25. The composite according to claim 1, wherein said at least one layer of soft carbon fiber felt has a weight per unit area in a range from 200 to 1,500 g/m².

26. The composite according to claim 1, wherein said at least one layer of soft carbon fiber felt has carbon fibers with a length in a range from 1 to 250.

27. The composite according to claim 1, wherein said at least one layer of soft carbon fiber felt has carbon fibers with a length in a range from 40 to 100 mm.

28. The composite according to claim 1, wherein said at least one layer of soft carbon fiber felt has carbon fibers with a fineness in a range from 0.5 to 25 dtex.

29. The composite according to claim 1, wherein said at least one layer of soft carbon fiber felt has carbon fibers with a fineness in a range from 1 to 5 dtex.

30. The composite according to claim 1, wherein said at least one layer of hard carbon fiber felt has a density in a range from 0.1 to 1.0 g/cm³.

31. The composite according to claim 1, wherein said at least one layer of hard carbon fiber felt has a density in a range from 0.15 to 0.3 g/cm³.

32. The composite according to claim 1, further comprising at least one graphite foil disposed on an outer side of one of said layers of soft or hard carbon fiber felt of the composite.

33. The composite according to claim 1, further comprising at least one layer of carbon fiber-reinforced carbon disposed on an outer side of one of said layers of soft or hard carbon fiber felt of the composite.

34. The composite according to claim 14, wherein said at least one graphite foil contains a natural graphite or an expanded graphite and has a layer thickness of from 0.3 to 1 mm.

35. The composite according to claim 14, wherein said at least one layer of carbon fiber-reinforced carbon contains one of continuous fibers or staple fibers having a length in a range from 10 to 100 mm.

36. The composite according to claim 14, wherein said at least one layer of carbon fiber-reinforced carbon contains one of continuous fibers or staple fibers having a length in a range from 50 to 100 mm.

37. The composite according to claim 14, wherein said at least one layer of carbon fiber-reinforced carbon has a density in a range from 0.8 to 2.0 g/cm³.

38. The composite according to claim 14, wherein said at least one layer of carbon fiber-reinforced carbon has a density in a range from 1.0 to 1.5 g/cm³.

39. A manufacturing method, which comprises the step of:
producing an article selected from the group consisting of thermal insulations, furnace internals, and an apparatus having high-temperature applications using a composite containing a binder, at least one layer of a soft carbon fiber felt, and at least one layer of a hard carbon fiber felt, the at least one layer of soft carbon fiber felt being joined via the binder to the at least one layer of hard carbon fiber felt.

40. A process for producing a composite, which comprises the steps of:
providing at least one layer of soft carbon fiber felt;
providing at least one layer of hard carbon fiber felt; and
joining of the at least one layer of soft carbon fiber felt to the at least one layer of hard carbon fiber felt by means of a binder.

41. The process according to claim 40, which further comprises producing the at least one layer of hard carbon fiber felt by impregnation of a soft carbon fiber felt with a further binder and subsequent heat treatment.

42. The process according to claim 40, which further comprises producing the at least one layer of hard carbon fiber felt by mixing of fibers with a further binder resulting in a fiber-binder mixture, pressing of the fiber-binder mixture and a subsequent heat treatment.

43. The process according to claim 40, which further comprises applying at least one of a graphite foil or a layer of carbon fiber-reinforced carbon to at least one of the layers of soft or hard carbon fiber felt.

44. The process according to claim 43, which further comprises:
carbonzing or graphiting peroxidized polyacrylonitrile fibers, polyacrylonitrile fibers and/or pitch fibers resulting in carbon fibers; and
processing the carbon fibers to give a woven fabric or a lay-up which is subsequently impregnated with the binder selected from the group consisting of phenolic resins, pitches, furan resins, phenyl esters, epoxy resins and any mixtures of at least two of the abovementioned compounds before a structure obtained in this way is carbonized or graphitized.
